(19) United States
(12) Patent Application Publication
(10) Pub. No.: US 2012/0248801 A1
(43) Pub. Date: Oct. 4, 2012

(54) Rear bumper hitch and guard

(76) Inventor: Yim Man WU, Elmhurst, NY (US)

(21) Appl. No.: 13/372,042

(22) Filed: Feb. 13, 2012

Related U.S. Application Data
(60) Provisional application No. 61/516,268, filed on Apr. 1, 2011.

(51) Int. Cl. B60R 19/44

(52) U.S. Cl. 293/142

(57) ABSTRACT

A bumper hitch and guard composed of a hitch bar and transverse bars for vehicles with trailer hitch receivers where the hitch bar is insertable and secured into the trailer hitch receiver of the vehicle, the bumper hitch and guard serving to protect the rear of the vehicle from damage. The bumper hitch and guard are easily removable.

### CROSS-REFERENCE TO RELATED APPLICATIONS

This application claims the benefit of U.S. Provisional Application No. 61/516,268, filed Apr. 1, 2011 and Design Application 29/374,147, filed Jul. 11, 201, the entirety of both of which are incorporated herein by reference.

### FIELD OF THE INVENTION

This invention relates generally to the field of guards used to protect bumpers on vehicles, and, more particularly, to guards to protect rear bumpers on autos, trucks, SUV's, and similar vehicles.

### BACKGROUND OF THE INVENTION

There are many devices available which may be used as guards to protect front bumpers of vehicles from damage. With few exceptions, these guards are bulky, being made of metal pipe often as large as three or more inches in diameter. In most cases, these are fitted to pickups and other trucks to protect headlights and grilles from damage by brush if and when the driver takes the vehicle off-road. These brush guards must be attached to the front of the vehicle by a process that may take hours. This process often involves drilling, fitting, and bolting. This fitting can be painstaking if parts are not perfectly sized or aligned. The process may be all but impossible if the vehicle has been heavily used causing it to have bent or misaligned parts.

Someone seeking a bumper hitch and guard available for attachment to the rear of a vehicle has fewer to choose among. These also must be installed using drilling, fitting, and bolting. These bumper guards are heavy and, once installed, are seldom removed. They are also often impractical for all but a few vehicles. Many vehicles have trunk lids, tailgates, rear doors, litigates, and similar body parts permitting access to compartments in the rear of the vehicle. A large, heavy rear bumper hitch and guard can prevent access to a trunk or rear compartment. Thus, these large, bulky guards are not a good solution to the problem of protecting the rear of a vehicle for most users.

For ordinary vehicles, including cars and SUV's, it is rare that such vehicles would be taken off road. Ordinary vehicles face other problems, however. Rear-end collisions, especially at low speed, are commonplace. Drivers sometimes back their own vehicles into hard objects, such as, lampposts, signposts, and trees. With the high cost of repair of bumpers and body parts, there has been a need for a better way to protect the rear of such an ordinary vehicle. The present invention solves that problem.

The present invention is lightweight and installs in seconds. Yet it protects the expensive rear bumper and rear parts of a vehicle from damage in many cases. The invention takes advantage of a vehicle's trailer hitch receiver. Such trailer hitch receivers are usually made of ferrous metal formed into a square tube and attached to the vehicle under the rear section of the vehicle. These alter hitch receivers are square and are available in two sizes—one-and-one-quarter inches in dimension on the horizontal and vertical sides and two inches in dimension on the horizontal and vertical sides. Lengths of these receivers may vary with model due to there being no standard vehicle underbody configuration.

Most trailer hitch receivers contain two apertures, one on each vertical side, and located directly opposite one another so that a pin or bolt may be inserted into the aperture on one side, pushed through, and the inserted end will project from the aperture on the opposite side. The trailer hitch receiver is not claimed as part of the present invention.

The present invention discloses a bumper hitch and guard. One part of the bumper hitch and guard is a hitch bar for insert on into a trailer hitch receiver. The hitch bar is square to match the size and shape of the trailer hitch receiver. The hitch bar is made in two sizes, one to fit into a one-and-one-quarter inch trailer hitch receiver and the other to fit into a two inch trailer hitch receiver with some tolerance to allow the hitch bar to easily slide in and out of the trailer hitch receiver. The length of a hitch bar may vary with the model of the vehicle on which it is to be installed. Most hitch bars are between four and twelve inches long but may be longer if necessary. It is not unusual for users to purchase a hitch bar longer than necessary for their application and to remove—or have removed—as much of the end of the hitch bar as they deem necessary to match personal preferences. Hitch bars may be constructed of solid material or may be hollow. Most hitch bars are made of ferrous metal but may be made of non-ferrous metal.

Hitch bars contain one or more pin apertures so located that the pin or bolt inserted through one pin aperture in the trailer hitch receiver, as described above, will pass through the corresponding pin aperture or apertures in the hitch bar and then through the aperture on the opposite side of the trailer hitch receiver where the user may lock the pin or bolt in place. If the hitch bar contains more than one pin aperture, the pin apertures may be spaced along the length of the hitch bar at any distance apart that a hitch bar manufacturer may consider functional as well as structurally sound. Hitch bars are well-known in the art.

The present invention, by employing widely-used trailer hitch receivers and hitch bars, provides many advantages. One is advantage of this invention is its low-cost. Existing, bolt-on bumper hitches and guards, consisting as they do of large amounts of metal, can cost hundreds of dollars. It can be costly to install an existing, bolt-on bumper hitch and guard considering the price of labor. The present invention costs but a fraction of what a large, heavy bumper hitch and guard costs and can be installed by almost anyone in a minute or two by inserting the hitch bar into the trailer hitch receiver and securing the hitch bar into place.

In addition, if a large, heavy bumper hitch and guard is damaged, such as, in a collision, it can be costly to remove and repair. The present invention, however, is removed by disconnecting the pin or attaching bolt and sliding the bumper hitch and guard out of the trailer hitch receiver. A replacement bumper hitch and guard can be installed in place of the damaged one in seconds.

The present invention can, in many low speed impacts, the most common ones, serve as a sacrificial element. An impact which would have damaged the rear bumper and body parts might damage only the rear bumper hitch and guard. Vehicle body repair often means being without one's vehicle for days on end. With the present invention in use, the owner of the auto incurs only the most minor inconvenience. The owner can make the repair with no need to be without the vehicle.

It is common in rear end impacts for taillights of vehicles to be damaged. It is illegal in many states to drive without taillights and it is dangerous to do so. Protecting the rear end of a vehicle from this type of damage adds an element of safety.

The above summary of the present invention and its advantages over the existing art are not intended to describe each illustrated embodiment, aspect, or every implementation of the present invention. The figures and detailed description and claims that follow more particularly exemplify these and other embodiments and further aspects of the invention.

### BRIEF DESCRIPTION OF THE DRAWINGS

The figures show the present invention in more detail.

FIG. 1 is a view of the bumper hitch and guard as seen from directly behind the vehicle (vehicle not illustrated).

FIG. 2 is a view of the bumper hitch and guard as seen from above.

FIG. 3 is a view of the bumper hitch and guard as seen from below.

FIG. 4 is a view of the bumper hitch and guard as seen from the right side where ‘right side’ refers to the right side of the vehicle when viewed from the rear (vehicle not illustrated).

FIG. 5 is a perspective view of the bumper hitch and guard as seen from above and to the right side of the vehicle (vehicle not illustrated).

While the invention is amenable to various modifications and alternative forms, specifics thereof have been shown by way of example in the drawings and will be described in detail. It should be understood, however, that the intention is not necessarily to limit the invention to the particular embodiments, aspects, and features described. On the contrary, the intention is to cover all modifications, equivalents, and alternatives falling within the spirit and scope of the invention and as defined by the appended claims.

### DETAILED DESCRIPTION OF THE INVENTION

With reference to the drawings, the invention will now be described in detail with regard for the best mode and preferred embodiment.

In this description, the term “vehicle” will refer to any vehicle on which the bumper hitch and guard is installed unless it is clear from the context that the term refers to a different type of vehicle. The term will include, but not be limited to, automobiles, trucks, SUV's, and even trailers if equipped with a hitch receiver.

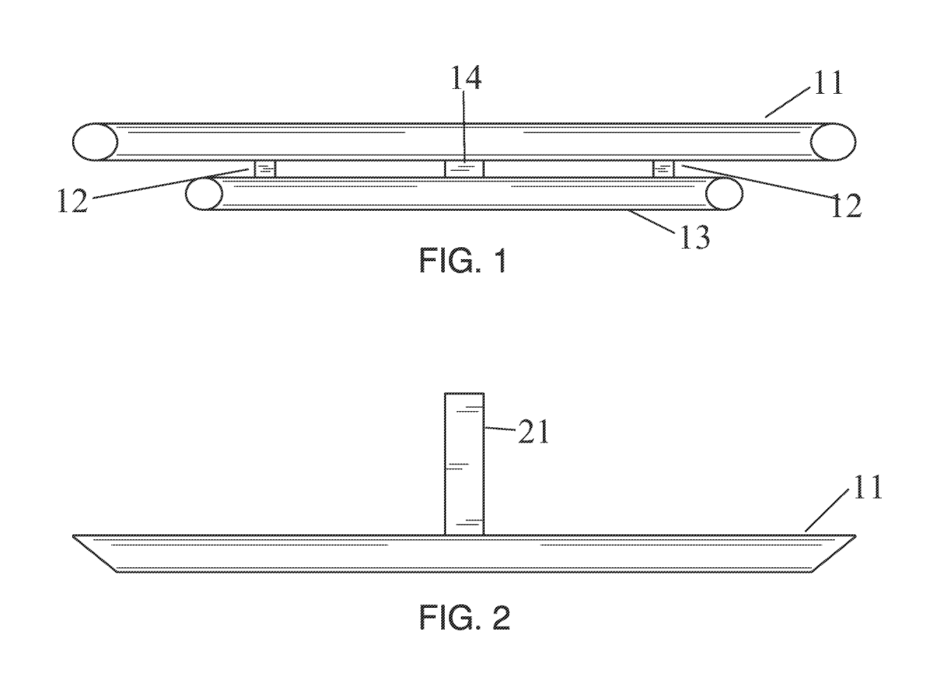

FIG. 1 shows upper transverse bar lit and lower transverse bar 13 from what would be the rear of the vehicle when the bumper hitch and guard are installed on the vehicle. These transverse bars 11 and 13 are constructed of metal from solid or hollow tubes. In the preferred embodiment, the metal is ferrous but the metal is non-ferrous in alternate embodiments. In the preferred embodiment, upper transverse bar 11 is 37 inches long and lower transverse bar 13 is 26 inches long. Upper and lower transverse bars 11 and 13 are joined to one another by two or more connectors 12 by methods well-known in the art.

Connectors 12 are short components welded or otherwise attached to upper transverse bar 11 and lower transverse bar 13. Connectors 12 are, in alternate embodiments, attached by bolts or screws to upper transverse bar 11 and lower transverse bar 13. In another embodiment, upper transverse bar 11, connectors 12, and lower transverse bar 13 are formed from a single casting. The lengths of connectors 12 will determine the distance separating upper transverse bar 11 from lower transverse bar 13. In one embodiment, connectors 12 are one-half inch long. Connectors 12 need not be the same length. Where connectors 12 are the same length, upper transverse bar 11 and lower transverse bar 13 lie parallel to one other. In the preferred embodiment, upper transverse bar 11 is longer than lower transverse bar 13. In another embodiment, upper transverse bar 11 is the same length as lower transverse bar 13. The relative positions of the upper transverse bar 11 and lower transverse bar 13 can be inverted by the user simply rotating the hitch bar 180 degrees about its long axis before inserting the hitch bar into the receiver.

FIG. 1 also shows one end 14 of hitch bar 21 (FIG. 2). Hitch bar end 14 is connected to upper transverse bar 11 and lower transverse bar 13 by means well-known in the art, including welding or bolting. In one embodiment, upper transverse bar 11, connectors 12, lower transverse bar 13, and hitch bar 21, including end 14, are formed by a single casting.

FIG. 2 shows a top view of upper transverse bar 11 as well as the upper side of hitch bar 21. In the preferred embodiment, upper transverse bar 11 is longer than lower transverse bar 13. Thus, lower transverse bar 13 is not visible in the top view.

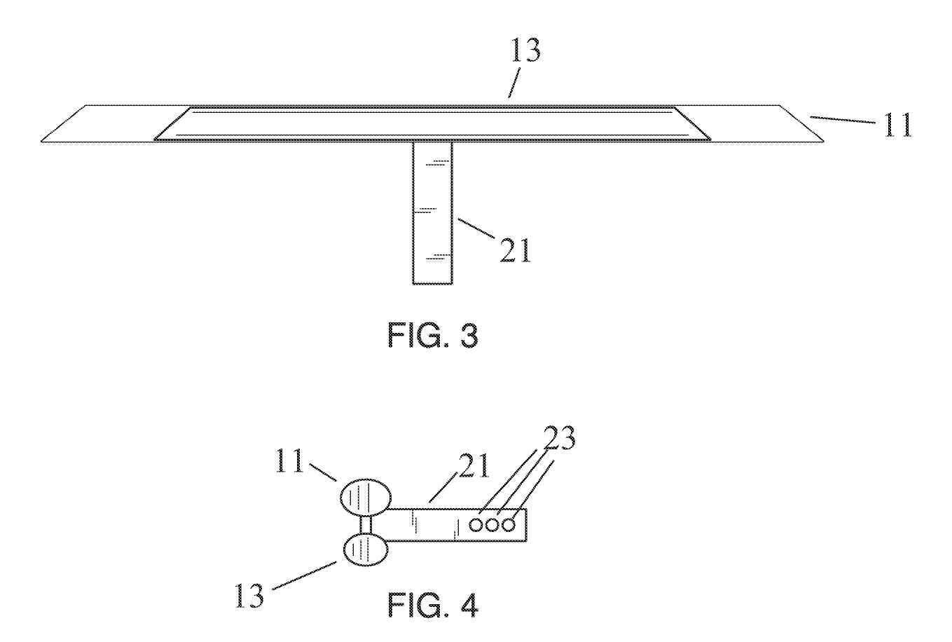

FIG. 3 shows a bottom view of lower transverse bar 13. In a bottom view of the preferred embodiment where upper transverse bar 11 is longer than lower transverse bar 13, the ends of the upper transverse bar 11 are visible beyond the ends of the lower transverse bar 13. Where upper transverse bar 11 and lower transverse bar 13 are the same length, upper transverse bar 11 would not be visible in this view.

FIG. 4 shows a side view of the bumper hitch and guard. Trailer hitch receivers are well-known in the art. In the vast majority of examples, trailer hitch receivers contain hollow square tubes into which hitch bars are inserted for attachment by means well-known in the art. Trailer hitch receivers are widely available in two main sizes where one size is one-and-one-quarter inch per side and the other size is two inches per side. To fit into these trailer hitch receivers, hitch bars, such as 21, are similarly available in sizes with sides one-and-one-quarter inches on the vertical and horizontal sides and two inches on the vertical and horizontal sides. In practice, these measurements are not exact. The hollow tube of the trailer hitch receiver is made slightly larger and the exterior dimensions of the sides of the hitch bar slightly smaller in order for the hitch bar to fit easily into the trailer hitch receiver.

Because the hitch bar 21 is square, it can be inserted into a trailer hitch receiver in any of four orientations, In the preferred embodiment, in which the upper transverse bar 11 is longer that the lower transverse bar 13, the hitch bar 21 is oriented with the upper transverse bar 11 above. A user, if so inclined, by rotating the hitch bar 21 about its long axis 180 degrees, could insert hitch bar 21 into a trailer hitch receiver so that upper transverse bar 11 lies below lower transverse bar 13.

Hitch bar 21 contains one or more pin apertures 23. Said pin apertures are, in the preferred embodiment, one-half inch in diameter and pass entirely through hitch bar 21. One or more pin apertures 23 are located on hitch bar 21 to match pin apertures in trailer hitch receivers. Said pin apertures 23 are adapted to receive a holding pin (not shown) which inserts through said pin apertures in said trailer hitch receiver to secure the bumper hitch and guard to the trailer hitch receiver. Precise locations of said pin apertures on both trailer hitch receivers and hitch bars 21 are standardized within the an and are not claimed in this invention.

The length of hitch bar 23 is, in the preferred embodiment, eight inches. However, other lengths are well-known within the art. Longer or shorter lengths determine how far beyond the trailer hitch receiver the bumper hitch and guard will position the upper transverse bar 11 and lower transverse bar 13. If, for example, the vehicle has a liftgate, it may require a longer hitch bar 21 so that a liftgate, when being raised, will not contact the bumper hitch and guard.

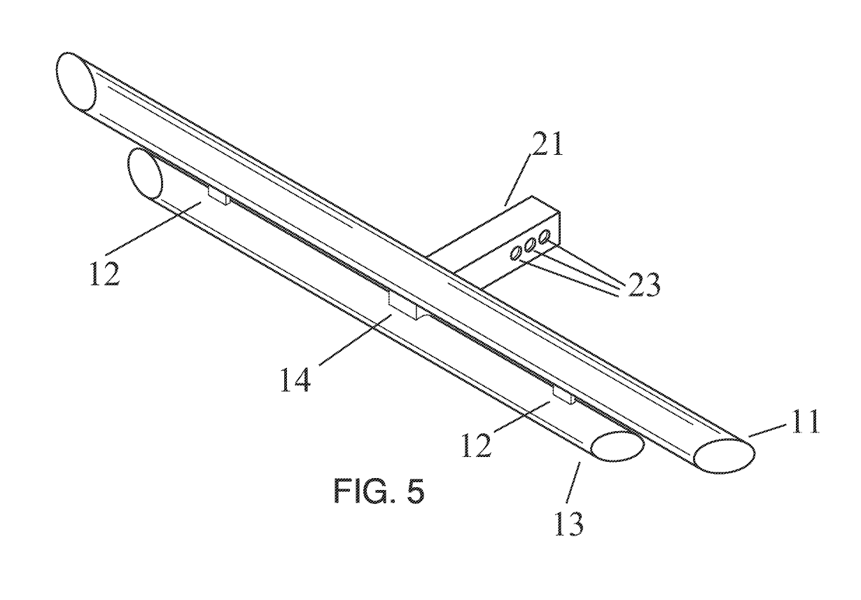

FIG. 5, the perspective view of the bumper hitch and guard, shows all parts of the invention in the preferred embodiment.

The above descriptions disclose a bumper hitch and guard with two transverse bars. In alternate embodiments the bumper hitch and guard comprise one or more transverse bars connected to the hitch bar such that the transverse bars lie parallel to the plane of the ground on which the vehicle stands.

It is understood that equivalents and substitutions for certain elements set forth above may be obvious to those skilled in the art, and, therefore, the true definition and scope of the invention are to be as set forth in the claims herewith.

What is claimed is:

1. A bumper hitch and guard for the rear of a vehicle having an existing trailer hitch receiver installed thereon, said bumper hitch and guard comprising:
a square hitch bar insertable into said existing trailer hitch receiver of the vehicle;
two transverse bars connected to one end of said hitch bar such that said transverse bars tie parallel to the plane of the ground on which the vehicle stands.

2. The hitch bar of claim 1 wherein the hitch bar has a length between four inches and twelve inches.

3. The hitch bar of claim 1 wherein the hitch bar has a length of eight inches.

4. The square hitch bar of claim 2 wherein each horizontal side and each vertical side of said square hitch bar is one-and-one-quarter inches in dimension.

5. The square hitch bar of claim 2 wherein each horizontal side and each vertical side of said square hitch bar is two inches in dimension.

6. The bumper hitch and guard of claim 1 wherein one of the two transverse bars is longer than the other transverse bar.

7. The bumper hitch and guard of claim 1 wherein the two transverse bars are the same length.

8. The bumper hitch and guard of claim 6 wherein the longer of the two transverse bars is 37 inches long.

9. The bumper hitch and guard of claim 6 wherein the shorter of the two transverse bars is 26 inches long

10. The bumper hitch and guard of claim 6 wherein the hitch bar is inserted in the trailer hitch receiver such that the longer of the two transverse bars is above the shorter of the two transverse bars.

11. The bumper hitch and guard of claim 6 wherein the hitch bar is inserted in the trailer hitch receiver such that the shorter of the two transverse bars is above the longer of the two transverse bars.

12. The bumper hitch and guard of claim 1 wherein the square hitch bar and the two transverse bars are composed of ferrous metal.

13. The bumper hitch and guard of claim 1 wherein the square hitch bar and the two transverse bars are composed of non-ferrous metal.

14. A bumper hitch and guard for the rear of a vehicle having an existing trailer hitch receiver installed thereon, said bumper hitch and guard comprising:
a square hitch bar insertable into said existing trailer hitch receiver of the vehicle;
one or more transverse bars connected to one end of said hitch bar such that said transverse bars tie parallel to the plane of the ground on which the vehicle stands.

15. The bumper hitch and guard of claim 14 wherein the square hitch bar and the one or more transverse bars are composed of ferrous metal.

16. The bumper hitch and guard of claim 14 wherein the square hitch bar and the one or more transverse bars are composed of non-ferrous metal. The square hitch bar of claim 14 wherein the hitch bar has a length between four inches and twelve inches.

17. The square hitch bar of claim 14 wherein the hitch bar has a length between four inches and twelve inches.

18. The square hitch bar of claim 14 wherein each horizontal side and each vertical side of said square hitch bar is two inches in dimension.

19. The square hitch bar of claim 14 wherein each horizontal side and each vertical side of said square hitch bar is one-and-one-quarter inches in dimension.

20. The bumper hitch and guard of claim 1 wherein one of the two transverse bars is longer than the other transverse bar.
